(19) United States
(12) Patent Application Publication
(10) Pub. No.: US 2022/0009491 A1
(43) Pub. Date: Jan. 13, 2022

(54) SYSTEMS AND METHODS FOR CONTROLLING A VEHICLE WITH RESPECT TO AN INTERSECTION

(71) Applicant: Toyota Research Institute, Inc., Los Altos, CA (US)

(72) Inventors: Yutaka Taruoka, Aichi (JP); Ryan Marcotte, Ann Arbor, MI (US); Hai Jin, Ann Arbor, MI (US); Hiroshi Nakamura, Tokyo (JP)

(73) Assignee: Toyota Research Institute, Inc., Los Altos, CA (US)

(21) Appl. No.: 16/925,466

(22) Filed: Jul. 10, 2020

(51) Int. Cl. B60W 30/18; B60W 40/105; B60W 40/04

(52) U.S. Cl. CPC B60W 30/18154; B60W 30/181; B60W 40/105; B60W 2554/80; B60W 2555/60; B60W 2556/40; B60W 2556/45; B60W 40/04

(57) ABSTRACT

Systems and methods for controlling a vehicle with respect to an intersection are disclosed. In one embodiment, a method of controlling a vehicle with respect to an intersection, includes determining a distance of the vehicle with respect to the intersection, wherein the intersection includes a traffic light, determining a velocity of the vehicle, and receiving traffic light state information regarding the traffic light. The method also includes calculating, based on the distance of the vehicle to the intersection, the velocity of the vehicle, and the traffic light state information, a zone of interest with respect to the traffic light. The method further includes manipulating the velocity of the vehicle to modify a size of the zone of interest when a current trajectory of the vehicle will cause the vehicle to enter the zone of interest.

### TECHNICAL FIELD

The present specification relates to systems and methods for controlling a vehicle and, more particularly, to systems and methods for controlling a vehicle with respect to a dilemma zone or an option zone at an intersection.

### BACKGROUND

Drivers of vehicles, as well as autonomous vehicles, may encounter a dilemma zone or an option zone near an intersection with a traffic light. Traffic lights cycle through several states to control the flow of vehicles through an intersection. For example a traffic light may have a green light that is illuminated for a first period of time, a yellow light that is illuminated for a second period of time and a red light that is illuminated for a third period of time. The green, yellow and red lights cycle through the sequence sequentially.

An option zone is an area of the road before a stop line of an intersection where a traffic light is yellow and a driver could drive through the intersection before the traffic light turns red or stop at the stop line. However, the driver may be indecisive and hesitate to stop the vehicle or driver through the intersection because he or she is unsure of when the light will turn red.

A dilemma zone is an area of the road before a stop line where a vehicle can neither travel through the intersection before the light turns red nor stop at the stop line due to the location of the vehicle with respect to the stop line and the current velocity of the vehicle.

Both the option zone and the dilemma zone may lead to undesirable outcome for both drivers and autonomously controlled vehicles.

Accordingly, alternative systems and methods for controlling vehicles through an intersection are desired.

### SUMMARY

In one embodiment, a method of controlling a vehicle with respect to an intersection, includes determining a distance of the vehicle with respect to the intersection, wherein the intersection includes a traffic light, determining a velocity of the vehicle, and receiving traffic light state information regarding the traffic light. The method also includes calculating, based on the distance of the vehicle to the intersection, the velocity of the vehicle, and the traffic light state information, a zone of interest with respect to the traffic light. The method further includes manipulating the velocity of the vehicle to modify a size of the zone of interest when a current trajectory of the vehicle will cause the vehicle to enter the zone of interest.

In another embodiment, a method of controlling a vehicle with respect to an intersection includes receiving traffic light state information regarding a traffic light at the intersection, wherein the traffic light state information includes a time remaining until a red state of the traffic light, determining a predicted position of the vehicle after the time remaining of a current state of the traffic light based on a current velocity of the vehicle, and determining a needed distance to stop the vehicle at a stop line of the intersection based on the current velocity of the vehicle. When the traffic light state information indicates a current green state and a distance between the stop line and the predicted position of the vehicle is less than the needed distance to stop such that the vehicle is predicted to enter a dilemma zone, the method includes outputting a reduced speed ratio signal to an accelerator control of the vehicle to decelerate the vehicle. When the traffic light state information indicates a current red state and a displacement between the predicted position and the stop line of the intersection is less than zero, the method includes outputting the reduced speed ratio signal to the accelerator control of the vehicle to decelerate the vehicle.

In yet another embodiment, a method of controlling a vehicle with respect to an intersection includes receiving traffic light state information regarding a traffic light, wherein the traffic light state information includes a current state and a minimum time remaining for the current state, and determining a distance to a stop line of the intersection. When the vehicle is within a predetermined distance of the stop line and the current state of the traffic light is a green state, the method includes calculating a predicted position of the vehicle at an end of the minimum time remaining for the green state, determining a maximum yellow passing distance X_{P} from the stop line that is the distance that the vehicle can travel from when the traffic light changes to a yellow state until it changes to a red state, and determining a minimum stopping distance X_{S} from the stop line. The method also includes, when the vehicle is within a predetermined distance of the stop line and the current state of the traffic light is a green state, determining a zone of interest prior to the stop line, which is an area defined by a difference between the greater of the maximum yellow passing distance X_{P} and the minimum stopping distance X_{S} and the other of the maximum yellow passing distance X_{P} and the minimum stopping distance X_{S}. The method further includes, when the predicted position of the vehicle is within the zone of interest, controlling the vehicle to decelerate such that the predicted position of the vehicle is not within the zone of interest.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts an example dilemma zone at an example intersection according to one or more embodiments described and illustrated herein;

FIG. 1B schematically depicts an example option zone at an example intersection according to one or more embodiments described and illustrated herein;

FIG. 2 schematically depicts an example vehicle receiving example traffic light state information from an example traffic light according to one or more embodiments described and illustrated herein;

FIG. 3 schematically illustrates an example reduced option zone according to one or more embodiments described and illustrated herein;

FIG. 4 schematically illustrates an example reduced dilemma zone according to one or more embodiments described and illustrated herein;

FIG. 5 graphically illustrates an example dilemma zone according to one or more embodiments described and illustrated herein;

FIG. 6A schematically illustrates an example vehicle within an example option zone;

FIG. 6B schematically illustrates the example vehicle of FIG. 6A avoiding a reduced option zone according to one or more embodiments described and illustrated herein;

FIG. 7A schematically illustrates an example vehicle within an example dilemma zone;

FIG. 7B schematically illustrates the example vehicle of FIG. 7B avoiding a reduced dilemma zone according to one or more embodiments described and illustrated herein;

FIG. 8 schematically illustrates an example system for detecting a zone of interest and controlling a vehicle to avoid the zone of interest according to one or more embodiments described and illustrated herein; and

FIG. 9 schematically illustrates an example computing system for detecting a zone of interest and controlling a vehicle to avoid the zone of interest according to one or more embodiments described and illustrated herein.

### DETAILED DESCRIPTION

The embodiments disclosed herein describe systems and methods for controlling a vehicle with respect to an intersection. Drivers of vehicles and autonomous vehicles may encounter a dilemma zone or an option zone (collectively referred to herein as a “zone of interest”) near an intersection with a traffic light. A traffic light may have a green light that is illuminated for a first period of time, a yellow light that is illuminated for a second period of time and a red light that is illuminated for a third period of time.

Embodiments of the present disclosure assist in navigating a vehicle with respect to a zone of interest of an intersection. An option zone is an area of the road before a stop line of an intersection where a traffic light is yellow and a driver could drive through the intersection before the traffic light turns red or stop at the stop line. However, the driver may be indecisive and hesitate to stop the vehicle or drive through the intersection because he or she is unsure of when the light will turn red.

A dilemma zone is an area of the road before a stop line where a vehicle can neither travel through the intersection nor stop at the stop line before the light turns red due to the location of the vehicle with respect to the stop line and the current velocity of the vehicle.

As described in detail herein, embodiments of the present disclosure predict when a vehicle (whether driven manually by a human or autonomously by computer control) will end up in, and be affected by, a zone of interest, and control the speed of the vehicle to minimize the zone of interest so that it is avoided. Embodiments receive traffic light state information and monitor the trajectory of the vehicle to predict when it will be affected by a zone of interest, and may reduce the speed of the vehicle in advance of the intersection to avoid the zone of interest.

Various embodiments of systems and methods for controlling a vehicle with respect to an intersection to avoid a zone of interest are described in detail below.

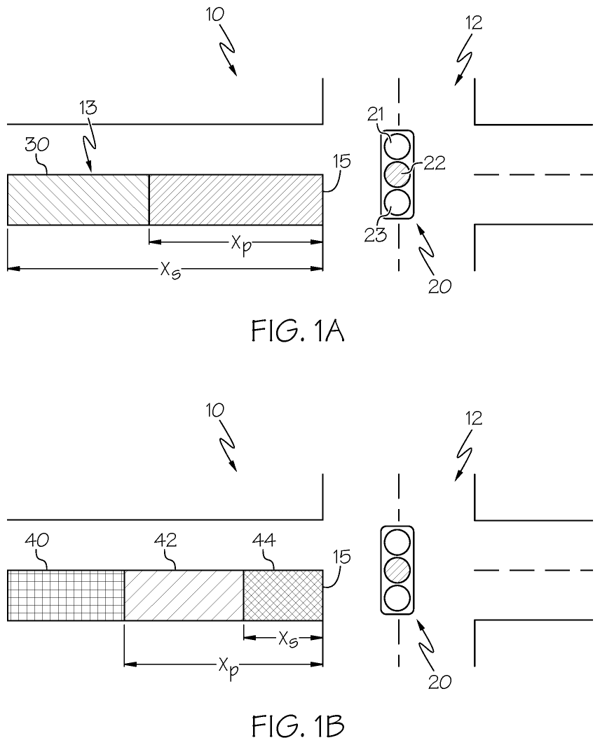

Referring now to FIG. 1A, an example roadway 10 depicting a dilemma zone 30 is schematically illustrated. The example roadway 10 has an intersection 12 with a traffic light 20 that controls the flow of vehicles through the intersection 12. The example traffic light 20 has a green light 21 for a green state when illuminated, a yellow light 22 for a yellow state when illuminated, and a red light 23 for a red state when illuminated. It should be understood that embodiments are not limited to any type of traffic light or configuration of traffic light. For example, the traffic light may provide for additional states, such as a yellow turn arrow, a green turn arrow, and the like. Embodiments of the present disclosure may operate with any type of traffic control device, such as traffic lights.

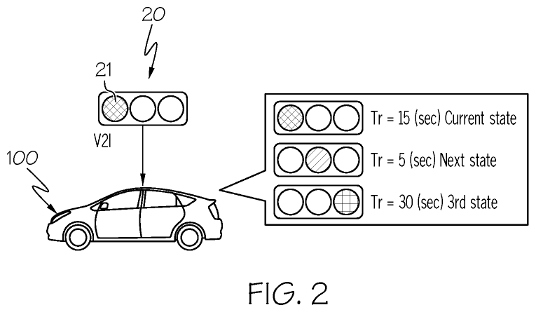

Referring now to FIG. 2, a vehicle 100 in communication with a traffic light 20 is schematically illustrated. A traffic light typically has scheduled state information, which is the order in which the different lights are illuminated and an amount of time each light is illuminated. In the illustration of FIG. 2, the traffic light provides a time remaining Tr for each colored light. For example, the green light 21 may currently be illuminated and have a time remaining Tr of 15 seconds until the next state. The next state is the yellow state that has a time remaining Tr of 5 seconds. The third state in the sequence is the red state that has a time remaining Tr of 30 seconds.

In embodiments of the present disclosure, the vehicle 100 receives the traffic light state information from an external source, such as from the traffic light itself (e.g., by a vehicle-to-infrastructure communication protocol), from a dedicated electronic communication device proximate the intersection (e.g., by a vehicle-to-infrastructure communication protocol), or from a remote server (e.g., by a wireless communication protocol). The traffic light state information may include, without limitation, a current state (i.e., the state that is currently active), one or more scheduled states, and a minimum time remaining for the current state, a minimum time remaining for the one or more scheduled states. In some embodiments, the traffic light state information may also include a maximum time remaining for the current state and the one or more scheduled states.

The vehicle 100 receives the traffic light state information and uses it to predict a zone of interest, and whether or not the vehicle 100 will enter or otherwise be affected by the zone of interest. The dilemma zone and the option zone (i.e., the zones of interest) will be described in detail below.

Referring once again to FIG. 1A, the dilemma zone 30 is defined by a maximum yellow passing distance X_{P} and a minimum stopping distance X_{S}. The maximum passing distance X_{P} is the maximum distance at which a vehicle 100 can pass through the intersection 12 at the time the traffic light 20 changes to the yellow state based on the current velocity of the vehicle 100. The minimum stopping distance X_{S} is the minimum distance from the stop line 15 at which the vehicle 100 can successfully stop at the stop line 15 based on the current velocity of the vehicle 100. The dilemma zone 30 is the area of the present lane 13 of the vehicle 100 defined by the difference between the minimum stopping distance X_{S} and the maximum yellow passing distance X_{P}. When a vehicle 100 is present within the dilemma zone 30 when the traffic light 20 changes to the yellow state it can neither pass through the intersection before the traffic light 20 changes to the red state nor stop in time to stop at the stop line 15 of the intersection.

Referring now to FIG. 1B, an example option zone 42 at an intersection 12 is schematically illustrated. The option zone 42 is the area of the present lane 13 of the vehicle defined by the difference between the maximum yellow passing distance X_{P} and the minimum stopping distance X_{S}. FIG. 1B also illustrates a likely stop zone 40 where a driver will likely stop when the vehicle 100 is in this zone when the traffic light 20 turns yellow, and a likely pass zone 44 where the driver will likely pass through the intersection 12 when the traffic light 20 turns yellow. However, a driver may hesitate to pass through the intersection 12 or stop at the stop line 15 when the when the vehicle 100 is in the option zone 42 when the traffic light 20 turns yellow.

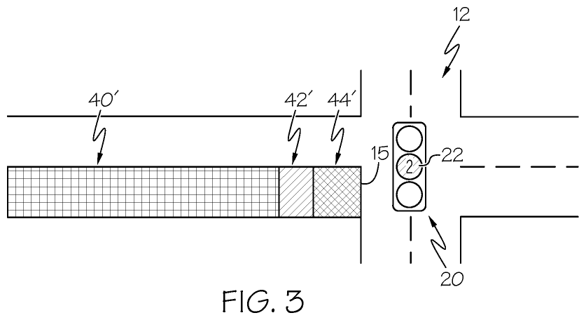

Referring to both FIGS. 1B and 3, the option zone 42 may be minimized by manipulating the velocity of the vehicle 100 prior to the intersection 12. For example, the option zone 42 may be minimized by decreasing the velocity of the vehicle 100. However, it should be understood that embodiments of the present disclosure may minimize the option zone by increasing the velocity of the vehicle 100. As shown in FIG. 3, the reduced option zone 42′ as a result of the embodiments of the present disclosure is smaller than the option zone 42 of FIG. 1B without option zone remediation. FIG. 3 illustrates that reducing the velocity of the vehicle 100 prior to the intersection 12 also increases the size of the likely stop zone 40′ and reduces the likely pass zone 44′ as compared to the example of FIG. 1B.

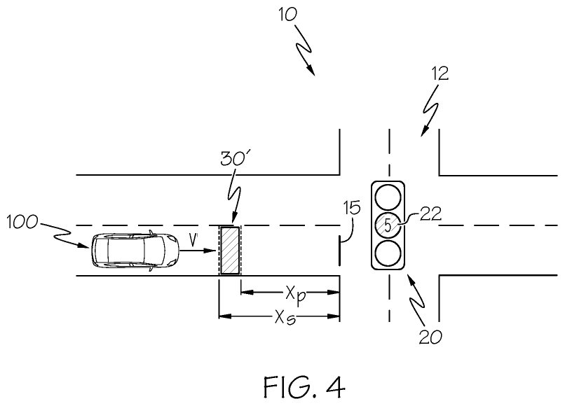

The dilemma zone 30 can also be reduced by the control methods and systems of the present disclosure. FIG. 4 illustrates an example when embodiments of the present disclosure are used to manipulate the velocity of the vehicle 100 in advance of the intersection 12 to produce a reduced dilemma zone 30′ when the yellow light 22 is illuminated. The reduced dilemma zone 30′ is smaller in length than the comparative dilemma zone 30 of FIG. 1B when no preventative action is taken to manipulate the dilemma zone 30. For example the velocity of the vehicle 100 may be reduced to reduce the size of the dilemma zone. However, it should be understood that embodiments of the present disclosure may also minimize the dilemma zone by increasing the velocity of the vehicle 100.

Thus, embodiments of the present disclosure are configured to manipulate the velocity of the vehicle to modify a size of the zone of interest by determining a distance of the vehicle with respect to the intersection, determining a velocity of the vehicle, receiving traffic light state information, and calculating the zone of interest using the distance of the vehicle to the intersection, the velocity of the vehicle, and the traffic light state information.

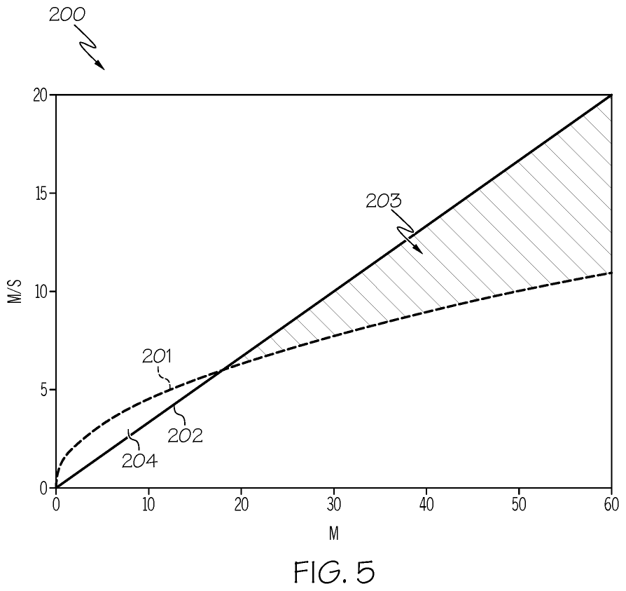

Referring now to FIG. 5, the dilemma zone 30 is graphically illustrated. Without slowing down, a vehicle traveling at a velocity of V m/s and L meters away from the stop line, and a traffic light will be yellow for Y seconds, the vehicle will be L−V*Y before the stop line when the traffic light turns red. With slowing down by D m/s² deceleration, the distance needed to stop the vehicle is V*V/(2*D). Thus, the dilemma zone conditions are:

L−V*Y>0 and V*V/(2*D)<L

For the case of Y=3 seconds and D=1 m/s², the area above plot line 202 is the case where the vehicle can pass the stop line (L−V*Y>0) and the area below plot line 201 is the case where the vehicle can stop before the stop line at D=1 m/s² (V*V/(2*D)<L) The combinations of L and V for the dilemma zone are shown in the shaded area 203 of the graph of FIG. 5, wherein the horizontal axis represents the distance to the stop line when the traffic light turns yellow, and the vertical axis is the velocity of the vehicle. Area 204 between plot line 201 and 202 is the option zone where a driver may hesitate to stop or drive through the intersection.

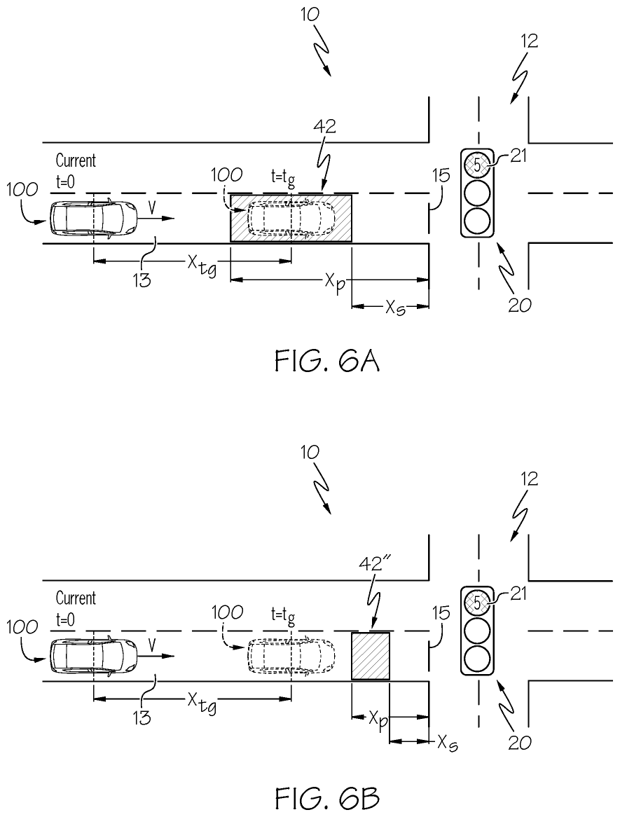

Referring now to FIG. 6A, an example illustrating an example vehicle 100 being present in an option zone 42 when the traffic light 20 changes from a green light to a yellow light at time t_{g}. The prediction of the location of the vehicle 100 at the conclusion of time t_{g} (referred to as predicted position X_{tg}) uses parameters of the vehicle as well as the traffic light state information received from the traffic light 20 or some other source. The calculation of the maximum yellow passing distance X_{P}, the minimum stopping distance X_{S}, and the predicted position X_{tg} is provided by the equations below:

$$\begin{matrix}{X}_{S} = \frac{{v}^{2}}{2 {d}_{max}} , & Eq . ( 1 ) \\ {X}_{P} = v α {t}_{y} + 0.5 {a}_{max} β {t}_{y}^{2} - L , & Eq . ( 2 ) \\ {X}_{tg} = {vt}_{g} + \frac{{v}^{2}}{2 a} , & Eq . ( 3 )\end{matrix}$$

where:
X_{S} is the minimum stopping distance,
X_{P} is the maximum yellow passing distance,
X_{tg} is the predicted distance (i.e., the predicted location at the conclusion of the green light at t_{g}),
v is the velocity of the vehicle,
a is the acceleration of the vehicle,
aₘₐₓ is the maximum acceleration of the vehicle,
dₘₐₓ is the maximum deceleration of the vehicle,
t_{y} is the duration of the yellow signal,
t_{g} is the duration of the green signal,
L is the length of the vehicle plus the proceed distance during the actuator of the vehicle reaction time, and
α, β are weighting factors such as 0<α≤1, 0<β≤1.

The remaining time t_{y} and t_{g} is received from the traffic light, such as by vehicle-to-infrastructure (V2I) protocol, for example. By using the time information of the traffic light state information that is received, X_{P}, X_{S} and X_{tg} is estimated using Equations (1)-(3) above to predict the risk of the vehicle 100 being in the option zone at the conclusion of time t_{g}. The weighting factors α, β are related to t_{y} to adjust X_{P} to optimize the braking input. These weighting factors provide for smooth control of the vehicle for passenger comfort.

If the vehicle 100 is likely to be present in the option zone the maximum yellow passing distance X_{P}, the minimum stopping distance X_{S} and the predicted distance X_{tg} can be controlled by changing the acceleration of the vehicle 100. This will cause the vehicle 100 to avoid being in the option zone after time t_{g}. As shown in FIG. 6B, slowing down the vehicle 100 causes a reduced option zone 42″ as compared to the option zone 42 shown in FIG. 6A. FIG. 6B shows that the vehicle 100 will be in front of the reduced option zone 42″ at the conclusion of time t_{g}.

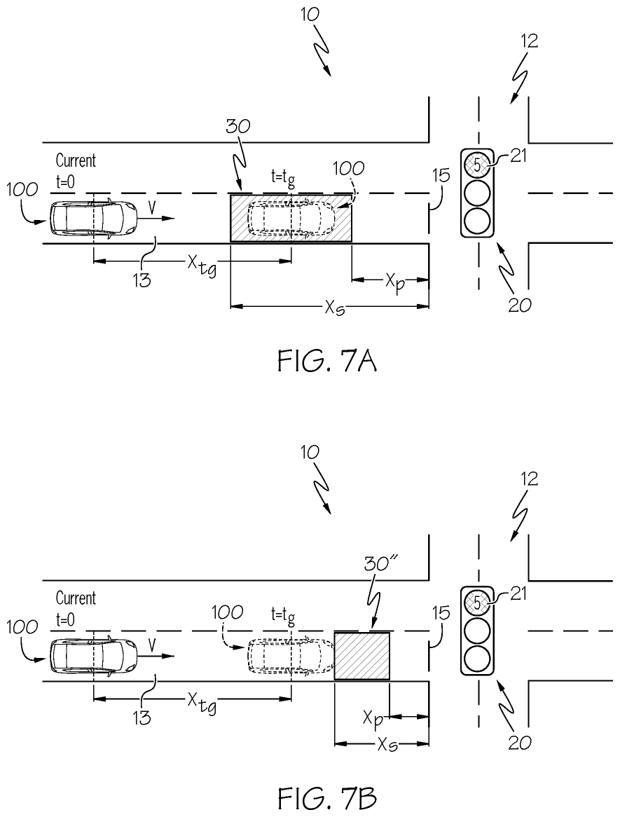

Similarly, the acceleration of the vehicle 100 can be controlled to reduce the size of a dilemma zone 30. FIG. 7A shows an example of how the vehicle 100 is predicted to be within the dilemma zone 30 at the conclusion of time t_{g}. FIG. 7B shows a reduced dilemma zone 30″ as a result of decelerating the vehicle 100. The reduced dilemma zone 30″ ensures that the vehicle is not within the reduced dilemma zone 30″ at the conclusion of time t_{g}.

It is noted that the process for determining whether or not the vehicle will be within a zone of interest may be initiated at a predetermined distance from the stop line of the Tr (i.e., the distance from the stop line is less than a predetermined threshold) so that the vehicle may be decelerated in a smooth manner without causing discomfort to the passengers of the vehicle.

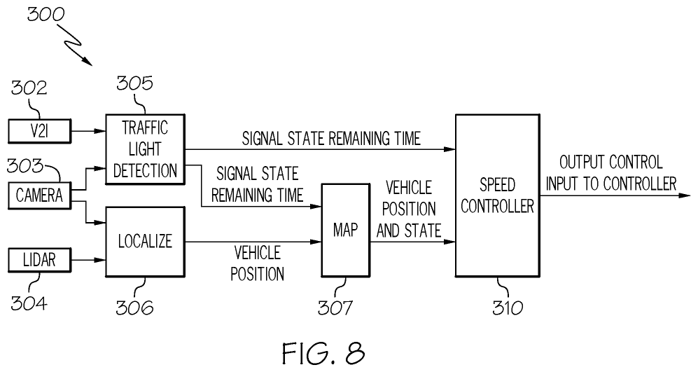

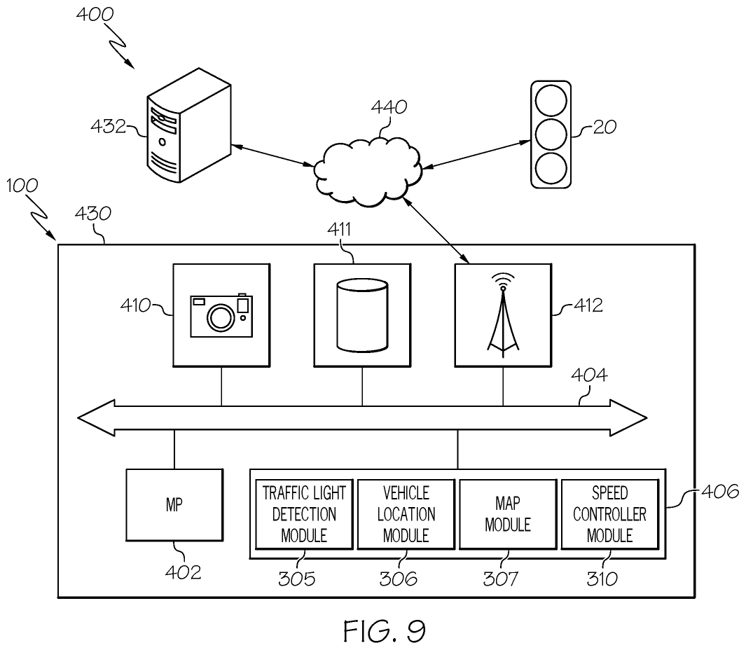

Referring now to FIG. 8, an example system 300 for controlling a vehicle with respect to an intersect to avoid a zone of interest is illustrated. It should be understood that more or fewer components may be utilized to perform the functionalities described herein. The components of FIG. 8 may be embodied by hardware and/or software components, such as the hardware and software components described below with respect to FIG. 9.

A traffic light detection module 305 is configured to detect the presence of a traffic light as the vehicle approaches an intersection and receives traffic light state information. The traffic light detection module 305 may detect a traffic light by any means. In the example of FIG. 8, the traffic light detection module 305 receives as input traffic light state information 302 from V2I signals and image data from one or more camera sensors 303. When the vehicle receives traffic light state information, it is indicative that the vehicle is approaching a traffic light. Additionally, any known or yet-to-be-developed object detection algorithm may be performed on the image data to detect an upcoming traffic light. The output of the traffic light detection module 305 is all or some of the traffic light state information, which includes the remaining time for the states of the traffic light. Thus, the traffic light detection module 305 publishes not only the current signal state of the remaining time of the current state and, in some embodiments, the remaining time for the other states.

The example system 300 further includes vehicle location module 306 that outputs a vehicle position. The vehicle location module 306 may determine the location of the vehicle by any means. In the example of FIG. 8, the vehicle location module 306 receives as input image data from the one or more camera sensors 303 and light detection and ranging (LiDAR) data from one or more LiDAR sensors 304. The image data and the LiDAR data is used to find a position of the vehicle within the environment, such as what lane the vehicle is traveling in, which may be important in determining which lights of a traffic light(s) controls the movements of the vehicle.

The example system 300 further includes a map module 307 that maps the traffic light state, the current traffic light state remaining time, the vehicle state (e.g., it receives the parameters of the vehicle, such as velocity, acceleration, and the like), and localized data on a map. The map module 307 may access one or more maps of the environment, such as a high definition map. The map module 307 outputs a position of the vehicle with respect to map data as well as the state of the vehicle.

A speed controller module 310 is responsible for detecting a zone of interest, and decelerating the vehicle 100 when needed. The speed controller module 310 receives as input the traffic light status information (e.g., the signal state remaining time for the current state and the scheduled states) from the traffic light detection module 305 and the vehicle position and vehicle state from the map module 307. The speed controller module 310 detects the zone of interest with the signal state and remaining time and the vehicles position with respect to the map data and/or real-time sensor data from the one or more cameras 303 and the one or more LiDAR sensors 304. The output of the speed controller module 310 is a control signal that is provided to a vehicle controller, such as a controller for controlling an accelerator for the vehicle 100 (e.g., the gas pedal for an internal combustion engine or the accelerator pedal for an electric vehicle).

In some embodiments, the speed controller module 310 decelerates the vehicle 100 in a slow and controlled manner that is comfortable to the passengers of the vehicle 100. When the vehicle 100 is within a predetermined distance of the stop line and the current state of the traffic light is a green state, a zone of interest routine may be performed by the speed controller. For example, when the traffic light is green and the predicted position X_{tg} is beyond the stop line (i.e., the predicted distance between the predicted position X_{tg} and the stop line 15 is negative (any position beyond the stop line 15 is negative), the vehicle 100 can pass through the intersection before the light turns yellow. In this instance, the speed controller module 310 takes no action.

However, when the speed controller module 310 determines that the vehicle 100 will be in a zone of interest (i.e., an area defined by a difference between the greater of the maximum yellow passing distance X_{P} and the minimum stopping distance X_{S} and the other of the maximum yellow passing distance X_{P} and the minimum stopping distance X_{S}), a reduced speed ratio is applied to the output of the speed controller module 310 to incrementally reduce the speed of the vehicle. For example, a reduced speed ratio may be 0.01. Each time the reduced speed ratio is applied, the speed controller module 310 again determines whether or not the vehicle 100 will be in the zone of interest. The reduced speed ratio will be updated again if it is not enough to avoid the zone of interest.

As an example, when a distance between the stop line 15 and the predicted position X_{tg} of the vehicle is less than a minimum stopping distance such that the vehicle will stop within a dilemma zone, the speed controller outputs the reduced speed ratio. As another example, when the traffic light state information indicates a current red state and a displacement between the predicted position and the stop line of the intersection is less than zero, the speed controller module 310 outputs the reduced speed ratio to decelerate the vehicle 100.

FIG. 9 depicts an example computing system 400 for performing the functionalities as described herein. In some embodiments, the computing system 400 may include a vehicle 100 comprising a computing device 430. The example computing device 430 of the computing system 400 includes one or more processors 402, a communication path 404, one or more memory modules 406, one or more sensors 410, network interface hardware 412, and a data storage device 411, the details of which will be set forth in the following paragraphs. It should be understood that the computing system 400 of FIG. 9 is provided for illustrative purposes only, and that other computing systems comprising more, fewer, or different components may be utilized.

Each of the one or more processors 402 may be any device capable of executing computer readable and executable instructions. Accordingly, each of the one or more processors 402 may be a controller, an integrated circuit, a microchip, a computer, or any other computing device. The one or more processors 402 are coupled to a communication path 404 that provides signal interconnectivity between various modules of the computing system 400. Accordingly, the communication path 404 may communicatively couple any number of processors 402 with one another, and allow the modules coupled to the communication path 404 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 404 may be formed from any medium that is capable of transmitting a signal such as, for example, conductive wires, conductive traces, optical waveguides, or the like. In some embodiments, the communication path 404 may facilitate the transmission of wireless signals, such as WiFi, Bluetooth®, Near Field Communication (NFC) and the like. Moreover, the communication path 404 may be formed from a combination of mediums capable of transmitting signals. In one embodiment, the communication path 404 comprises a combination of conductive traces, conductive wires, connectors, and buses that cooperate to permit the transmission of electrical data signals to components such as processors, memories, sensors, input devices, output devices, and communication devices. Accordingly, the communication path 404 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The computing system 400 includes one or more memory modules 406 coupled to the communication path 404. The one or more memory modules 406 may comprise RAM, ROM, flash memories, hard drives, or any device capable of storing computer readable and executable instructions such that the computer readable and executable instructions can be accessed by the one or more processors 402. The computer readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into computer readable and executable instructions and stored on the one or more memory modules 406. Alternatively, the computer readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory modules 106 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. The one or more memory modules 406 include logic in the form of computer readable instructions that perform the functionalities described herein, such as the traffic light detection module 305, the vehicle location module 306, the map module 307, and the speed controller module 310. Additional logic used to support these functionalities may be stored in the one or more memory modules 406 and/or in remote memory modules.

The data storage device 411, which may generally be a storage medium, may contain one or more data repositories for storing data that is received and/or generated, and may be any physical storage medium, including, but not limited to, a hard disk drive (HDD), memory, removable storage, and/or the like. While the data storage device 411 is depicted as a local device, it should be understood that the data storage device 70 may be a remote storage device, such as, for example, a server computing device or the like. In some embodiments, the data storage device stores map information, such as the high-definition map data described above. It should be understood that the data storage device is not provided in some embodiments.

Still referring to FIG. 9, the computing system 400 may comprise network interface hardware 412 for communicatively coupling the computing system 400 to a remote computing device, such as, without limitation, the traffic light 20 and/or a remote server. The network interface hardware 412 can be communicatively coupled to the communication path 404 and can be any device capable of transmitting and/or receiving data via a network 440. Accordingly, the network interface hardware 412 can include a communication transceiver for sending and/or receiving wireless communications. For example, the network interface hardware 412 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 412 includes hardware configured to operate in accordance with the Bluetooth® wireless communication protocol. In some embodiments, the network interface hardware 412 is configured to communicate with remote computing devices by V2I and/or vehicle-to-vehicle (V2V) communication protocols.

It should now be understood that embodiments of the present disclosure are directed to systems and methods for controlling a vehicle with respect to an intersection to avoid a zone of interest, such as a dilemma zone or an option zone. Embodiments predict a zone of interest in advance of the vehicle arriving at the intersection and control the velocity of the vehicle when the vehicle is predicted to be within the zone of interest. Thus, drivers and autonomous vehicles will avoid a dilemma zone situation where the vehicle cannot proceed through the intersection before the traffic light turns red nor stop at the stop line, and avoid an option zone where a driver may hesitate in deciding whether to drive through the intersection or stop at the stop line.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of controlling a vehicle with respect to an intersection, the method comprising:
determining a distance of the vehicle with respect to the intersection, wherein the intersection includes a traffic light;
determining a velocity of the vehicle;
receiving traffic light state information regarding the traffic light;
calculating, based on the distance of the vehicle to the intersection, the velocity of the vehicle, and the traffic light state information, a zone of interest with respect to the traffic light; and
manipulating the velocity of the vehicle to modify a size of the zone of interest when a current trajectory of the vehicle will cause the vehicle to enter the zone of interest.

2. The method of claim 1, wherein the zone of interest is a dilemma zone such that the vehicle can neither stop at a stop line of the intersection nor pass through the intersection prior to the traffic light transitioning to a red state.

3. The method of claim 1, wherein the zone of interest is an option zone.

4. The method of claim 1, wherein the traffic light state information comprises a current state, one or more scheduled states, and a minimum time remaining for the current state.

5. The method of claim 4, wherein the traffic light state information further comprises a minimum time remaining for the one or more scheduled states and a maximum time remaining for the current state and the one or more scheduled states.

6. The method of claim 1, wherein the traffic light state information is received from a source external to the vehicle.

7. The method of claim 1, further comprising:
determining a location of the intersection by referencing map data;
determining a present lane of the vehicle;
determining a stop line at the intersection; and
calculating the zone of interest based at least in part on the location of the stop line at the intersection and the present lane of the vehicle.

8. The method of claim 7, further comprising calculating a predicted position after a time remaining until the traffic light is red based on the current trajectory.

9. The method of claim 1, wherein manipulating the velocity of the vehicle comprises decreasing the velocity of the vehicle.

10. The method of claim 9, wherein the velocity of the vehicle is decreased by applying a reduced speed ratio.

11. The method of claim 1, wherein manipulating the velocity of the vehicle is initiated at a predetermined distance from a stop line of the intersection.

12. A method of controlling a vehicle with respect to an intersection, the method comprising:
receiving traffic light state information regarding a traffic light at the intersection, wherein the traffic light state information comprises a time remaining until a red state of the traffic light;
determining a predicted position of the vehicle after the time remaining of a current state of the traffic light based on a current velocity of the vehicle;
determining a needed distance to stop the vehicle at a stop line of the intersection based on the current velocity of the vehicle; and
when the traffic light state information indicates a current green state and a distance between the stop line and the predicted position of the vehicle is less than the needed distance to stop such that the vehicle is predicted to enter a dilemma zone, outputting a reduced speed ratio signal to an accelerator control of the vehicle to decelerate the vehicle.

13. The method of claim 12, wherein the predicted position of the vehicle, the needed distance to stop, and the traffic light state information are iteratively determined such that the current velocity of the vehicle is iteratively reduced.

14. The method of claim 12, wherein the traffic light state information comprises the current state, one or more scheduled states, and minimum time remaining for the current state.

15. The method of claim 14, wherein the traffic light state information further comprises a minimum time remaining for the one or more scheduled states and a maximum time remaining for the current state and the one or more scheduled states.

16. The method of claim 12, further comprising determining a distance of the vehicle from the stop line of the intersection such that determining the predicted position of the vehicle and determining the needed distance to stop is performed when the distance of the vehicle from the stop line is less than a predetermined threshold.

17. A method of controlling a vehicle with respect to an intersection, the method comprising:
receiving traffic light state information regarding a traffic light, wherein the traffic light state information comprises a current state and a minimum time remaining for the current state;
determining a distance to a stop line of the intersection; and
when the vehicle is within a predetermined distance of the stop line and the current state of the traffic light is a green state:
calculating a predicted position of the vehicle at an end of the minimum time remaining for the green state;
determining a maximum yellow passing distance X_{P} from the stop line that is the distance that the vehicle can travel from when the traffic light changes to a yellow state until it changes to a red state;
determining a minimum stopping distance X_{S} from the stop line;
determining a zone of interest prior to the stop line, which is an area defined by a difference between the greater of the maximum yellow passing distance X_{P} and the minimum stopping distance X_{S} and the other of the maximum yellow passing distance X_{P} and the minimum stopping distance X_{S}; and
when the predicted position of the vehicle is within the zone of interest, controlling a velocity of the vehicle such that the predicted position of the vehicle is not within the zone of interest.

18. The method of claim 17, wherein:
the zone of interest is an option zone such that the maximum yellow passing distance X_{P} is greater than the minimum stopping distance X_{S}; and
a length of the option zone is shortened by decelerating the vehicle such that the predicted position of the vehicle is not within the option zone.

19. The method of claim 17, wherein:
the zone of interest is a dilemma zone such that the minimum stopping distance X_{S} is greater than the maximum yellow passing distance X_{P}; and
a length of the dilemma zone is shortened by decelerating the vehicle such that the predicted position of the vehicle is not within the option zone.

20. The method of claim 17, wherein the traffic light state information is received from a source external to the vehicle.
